(19) United States
(12) Patent Application Publication
(10) Pub. No.: US 2018/0131708 A1
(43) Pub. Date: May 10, 2018

(54) Identifying Fraudulent and Malicious Websites, Domain and Sub-domain Names

(71) Applicant: F-Secure Corporation, Helsinki (FI)

(72) Inventors: Janne Pirttilahti, Helsinki (FI); Teemu Luotio, Helsinki (FI)

(21) Appl. No.: 15/805,709

(22) Filed: Nov. 7, 2017

(30) Foreign Application Priority Data
Nov. 9, 2016 (GB) 1618907.8

(51) Int. Cl. H04L 29/06; G06F 17/30

(52) U.S. Cl. CPC H04L 63/1416; G06F 17/30991; G06F 17/30867

(57) ABSTRACT

A method of identifying fraudulent and/or malicious Internet domain and sub-domain names includes: crawling the web to identify in-use domain and/or sub-domain names and storing these in a database together with data linking domain and sub-domain names that have been determined to be associated with suspicious behaviours; receiving a search term; searching the database to identify domain and/or sub-domain names that contain the search term or a derivative thereof and saving the results as a first list of possibly suspect domain and sub-domain names; identifying within said first list one or more domain and/or sub-domain names that appear to be clearly fraudulent and/or malicious; using said database to identify domain and/or sub-domain names that are linked, in the database, to the identified domain and/or sub-domain names; and combining the identified domain and/or sub-domain names to generate a second list of highly suspect domain and/or sub-domain names.

### TECHNICAL FIELD

The present invention relates to a method and system for identifying fraudulent and/or malicious websites, Internet domain names and Internet sub-domain names.

### BACKGROUND

Fraudulent or fake websites may take many forms. Phishing websites mimic the legitimate websites of, for example, a bank or a utility company. Users are encouraged to log in and their confidential details are then used to access bank accounts or to enable identity theft. Phishing websites often appear legitimate by using the logo and other graphics of a trusted website. However, the domain name or sub-domain of the phishing website will always differ from the genuine website, often by misspelling a company name, by omitting forward slashes or by suffixing or prefixing the company name with some other term. A fraudulent or fake websites website may alternatively use the company name as the domain name but use a different domain name extension, e.g. “companyname.biz” instead of the genuine “companyname.com”.

Fraudulent or fake websites commonly host malware, including viruses, spyware, ransomware and the like, which infects a user's computer when the user visits the fraudulent or fake website. Once installed or downloaded onto the user's computer, the malware can cause the computer to run more slowly, to crash or to become unusable. Malware distributed by means of fraudulent or fake websites can also affect entire networks, servers, etc.

A website, domain name or sub-domain name may also be considered fraudulent or malicious if it uses a company's brand assets, such as a registered trade mark, without permission. Websites may be designed to fool users into thinking that they are purchasing goods from a genuine retailer, or they may just be offering what are clearly counterfeit goods. On the other hand, malicious websites may use a brand asset to disparage or unfairly criticise the brand. Again, the domain/sub-domain names of these websites may differ only slightly from the legitimate names.

Known methods of identifying a fraudulent website include the use of blacklists, Jaccard distance calculations, LSH and MinHash. Blacklists are essentially lists of known fraudulent websites, to which new fraudulent websites are added as they are identified. Jaccard similarity uses word sets from the genuine and potentially fraudulent websites to evaluate their similarity. Locality-sensitive hashing (LSH) generates a hash code so that similar sites will have similar hash codes. Minhash uses a randomised algorithm to estimate the Jaccard distance between two sites.

Another method of detecting phishing sites is described in “HTML structure-based proactive phishing detection” by Marius Tibeica (published Aug. 1, 2010 by Virus Bulletin), in which an algorithm creates signatures based upon the HTML structure of a website rather than its visible content, and compares these signatures with those of known genuine and fraudulent websites.

When evaluating the similarity between a genuine and a potentially fraudulent website it is therefore possible to use methods which consider both the text string of the domain or sub-domain name or URL(s) of the website, and the content of its web pages i.e. text, images, layout, HTML structure etc.

However, all of the above methods have their limitations, in that they rely on knowing exactly what to analyse. Where the problem is to find all fraudulent and malicious websites misusing the brand assets of a particular company, the above methods are less useful. It also remains the case that humans are far more proficient than computer algorithms at deciding whether a particular website is clearly fraudulent.

Known methods and systems for identifying malicious and fraudulent web domain and sub-domain names are ineffective in so far as they do not encompass the entire world wide web and/or rely on accidental discovery. Even the discovery of a malicious and/or fraudulent web domain or sub-domain name does not easily lead to other related domain or sub-domain name.

### SUMMARY OF THE INVENTION

According to a first aspect there is provided a method of finding fraudulent and/or malicious Internet domain and sub-domain names. The method comprises: a) crawling the web to identify in-use domain and/or sub-domain names and storing these in a database together with data linking domain and sub-domain names that have been determined to be associated with suspicious behaviours; b) receiving a search term; c) searching the database to identify domain and/or sub-domain names that contain the search term or a derivative thereof and saving the results as a first list of possibly suspect domain and sub-domain names; d) identifying within said first list one or more domain and/or sub-domain names that appear to be clearly fraudulent and/or malicious; e) using said database to identify domain and/or sub-domain names that are linked, in the database, to the domain and/or sub-domain names identified in step d); and f) combining the domain and/or sub-domain names identified in steps d) and e) to generate a second list of highly suspect domain and/or sub-domain names.

Step d) of the method may comprise displaying the first list on a computer display and receiving a user input identifying said one or more domain and/or sub-domain names that appear to be clearly fraudulent and/or malicious.

The method may comprise: g) identifying within the first list, domain and/or sub-domain names pointing to resources similar to resources pointed to by the one or more clearly fraudulent and/or malicious domain and/or sub-domain names identified at step d); h) using the database to identify domain and/or sub-domain names that are linked, in the database, to the domain and/or sub-domain names identified in step g); and i) combining the domain and/or sub-domain names identified in step h) with the second list of highly suspect domain and/or sub-domain names.

The method may comprise: j) identifying within the first list, domain and/or sub-domain names pointing to resources similar to resources pointed to by domain and/or sub-domain names genuinely associated with the search term; k) using the database to identify domain and/or sub-domain names that are linked, in the database, to the domain and/or sub-domain names identified in step j); and l) combining the domain and/or sub-domain names identified in step k) with the second list of highly suspect domain and/or sub-domain names.

Similar resources may be identified using one or more of the following algorithms: Jaccard distance calculations, LSH, MinHash or combinations thereof.

The method may comprise: categorising the identified domain and/or sub-domain names according to a probability of said domain and/or sub-domain names being fraudulent; and identifying those domain and sub-domain names that have a high probability of being fraudulent, and using the database to identify domain and/or sub-domain names that are linked, in the database, to the domain and/or sub-domain names having a high probability of being fraudulent.

The search term may comprise a text string.

The method may comprise iteratively applying the aforementioned steps, wherein, at the end of each iteration, the resulting list is used to define a new search term.

The method may comprise carrying out said step of crawling the web using a web crawler hosted on one or more servers.

The method may be implemented on one or more servers and may comprise providing a client portal to which client computers can connect and via which said search term can be received from a client computer. The client portal may provide a means to present said second list to the client computer.

According to a second aspect there is provided a method of securing a computer system against malware and comprising using the method of the above first aspect of the invention to identify fraudulent and/or malicious Internet domain and sub-domain names, and blocking or restricting access to those Internet domain and sub-domain names at the computer system or at a network node to which the computer system is connected.

According to a third aspect there is provided a system for identifying fraudulent and/or malicious Internet domain and/or sub-domain names. The system comprises: a web crawler coupled to the world wide web to identify in-use domain and/or sub-domain names; a searchable database for storing identified in-use domain and/or sub-domain names and for storing data linking domain and sub-domain names that have been determined to be associated with suspicious behaviours; and a server comprising a memory and a processor. The server is configured to receive a search term, to search the database for domain and/or sub-domain names that contain the search term or a derivative thereof, and to save the results of the search in the memory as a first list of possibly suspect domain and sub-domain names. The server is further configured to identify one or more domain and/or sub-domain names, in the first list, that appear to be clearly fraudulent and/or malicious, and to search the database to identify domain and/or sub-domain names that are linked, in the database, to the one or more clearly fraudulent and/or malicious domain and/or sub-domain names. The server is configured to combine the identified linked domain and/or sub-domain names with the first list to generate a second list of highly suspect domain and/or sub-domain names.

According to a fourth aspect there is provided a computer program product comprising a computer storage medium having computer code stored thereon which, when executed on a computer system, causes the system to operate as a system according to the second aspect above.

### BRIEF DESCRIPTION OF THE DRAWINGS

FIG. 1 illustrates schematically a network architecture;

FIG. 2 illustrates genuine and potentially fake domain names; and

FIG. 3 illustrates a method of finding fraudulent and/or malicious Internet domain and sub-domain names.

### DETAILED DESCRIPTION

The method and system described below have the objective of identifying domain and/or sub-domain names that are either themselves intrinsically misleading or point to websites that are misleading, fraudulent, or malicious, or otherwise mis-use a brand name, trademark, or other brand asset. For convenience, these domain and/or sub-domain names are referred to collectively as “fraudulent domain names”.

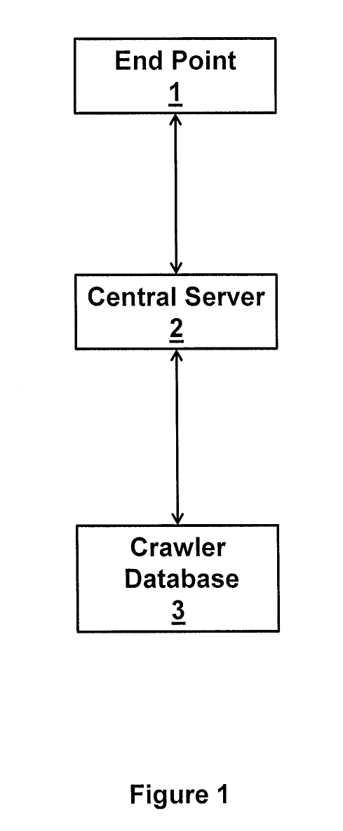

Described below with reference to FIGS. 1 to 3 are a method and system for identifying fraudulent domain names. The method and system make use of the “massive database” created by the present Applicant and known as “Riddler” (www.riddler.io), although alternative databases may also be used. The method and system address the challenges experienced when attempting to use existing technology to find not only phishing websites but any website which is misusing brand assets in some way. The identification of such websites, by way of their domain and/or sub-domain names, enables a brand owner, for example, to take action against this infringement of their intellectual property rights.

The aforementioned “massive database” is created using a web crawler which is an Internet “bot” that systematically browses the World Wide Web to identify in-use domain and/or sub-domain names. The Internet bot responsible for the crawling may be maintained by a security service provider. The data retrieved by the crawler is analysed in order to identify mappings between IP addresses and domain/sub-domain names, and associations between domain and sub-domain names. The identified in-use domain and/or sub-domain names are stored in the database together with the data linking domain and sub-domain names.

For example, a given web page retrieved from a domain/sub-domain may be parsed to identify links (i.e. hyperlinks) to other domain/sub-domain names. Web page data may also be parsed to identify other information, such as text, code, images etc. that may be useful in associating domain and sub-domain names, e.g. by matching common information. The crawler database thus contains all known IP addresses and the domains and sub-domains which are hosted at these IP addresses. The crawler database also contains details of linked and associated domain and sub-domain names. The content of the crawler database may be enriched using data collected from other sources. For example, data regarding domain and sub-domain names that have been determined to be associated with suspicious behaviours may also be stored in the database. Suspicious behaviours may include the hosting of malware.

As illustrated by FIG. 1, the crawler database 3 may consist of one or more separate databases, and communicates with a central server 2 operated by the security service provider. An operator of a network end point 1, such as a home computer, a server, or other device which may communicate with the server, may subscribe to the security services provider's service and communicate with the central server 2 via the internet.

The central server 2 may comprise physical hardware or may be implemented by way of a server cloud and/or distributed database.

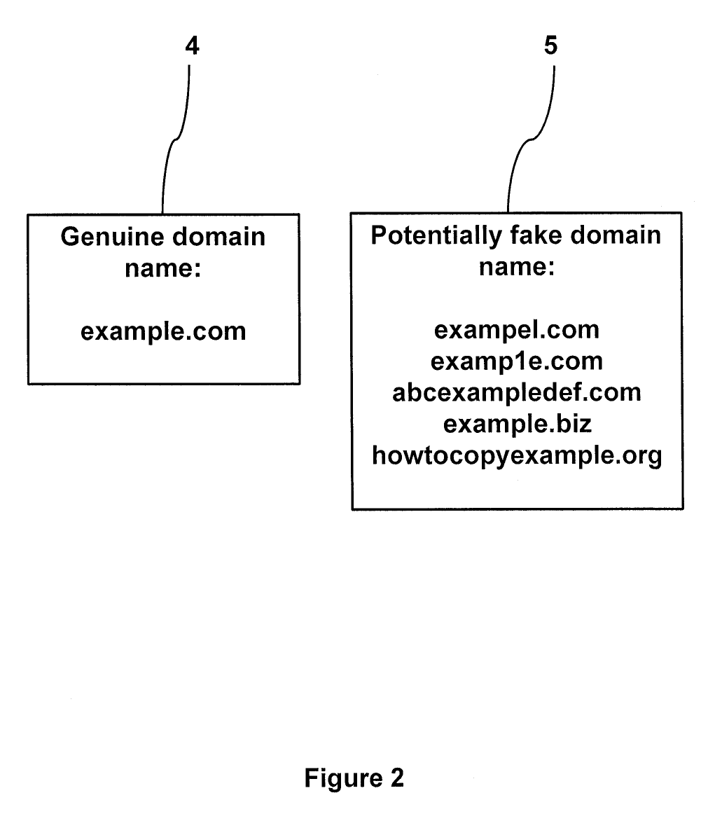

FIG. 2 illustrates a selection of potentially fake domain and/or sub-domain names 5, i.e. domain and/or sub-domain names hosting websites which incorporate and/or mimic the genuine websites (“example.com”). A wide range of alternative potentially fake domain and/or sub-domain names may be envisaged. These may include further examples of homoglyphs and typosquatting permutations, as well as partial matches of the whole host string (e.g. “abcexampledef.aaa.com”). It may be the domain or sub-domain name and/or the content of the web page itself that attempts to copy or mimic the genuine website.

It will be understood that a URL refers to an address which identifies one particular page or file on the Internet, and so a website having more than one page will encompass a number of URLs. The “main” or “home” page of a website may be identified by the domain name itself (e.g. “example.com” when entered into a browser will return the “main” or “home” page of the website, so in this sense the domain name may be considered to be an URL). In some cases, all of the URLs or pages/files which comprise the website may be fraudulent or malicious. In other cases, only some pages/files may be classifiable as such. Typically, all of the pages of a website will fall under a single domain or sub-domain. The pages of a website may be hosted on a single server having one IP address, or may be hosted on a plurality of servers with multiple IP addresses.

The described method seeks to identify domain and sub-domain names that are fraudulent and/or malicious. However, the method may alternatively or additionally supply details of a website (e.g. “example.com/index”), a URL (e.g. “example.com/shopping.htm”), a host and/or an IP address (e.g. “10.106.243.268”), or a combination of this information. Since a URL consists of a domain or sub-domain name identifying a host server, and a path to the web page/file on the host server (e.g. example.com/aboutus.htm), URLs can be associated with a particular domain, host server and its IP address. A user may therefore select whether the results returned by the method comprise lists of domain and/or sub-domain names or of URLs.

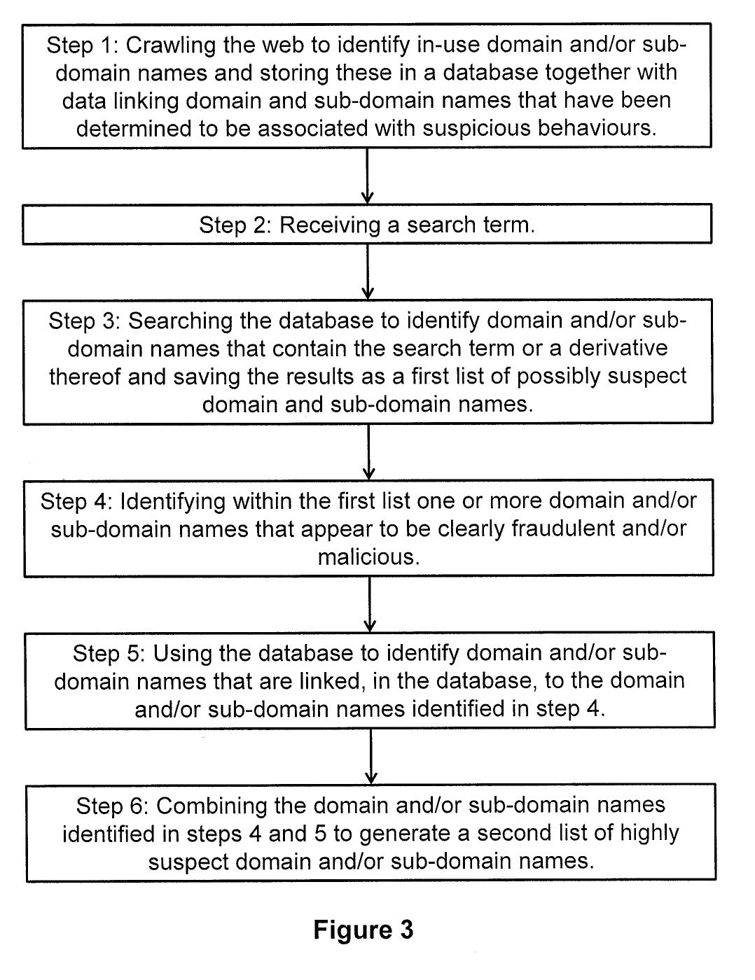

FIG. 3 illustrates a method of finding fraudulent and/or malicious domain and/or sub-domain names, using the “massive database” described above and illustrated in FIG. 1. The method comprises the following steps:

Step 1: Crawling the web to identify in-use domain and/or sub-domain names and storing these in a database together with data linking domain and sub-domain names that have been determined to be associated with suspicious behaviours. This makes use of the architecture illustrated in FIG. 1. This process is dynamic and continuous in order to take account of the constantly changing nature of the web, e.g. new domain and/or sub-domain names being added and existing domain and/or sub-domain names being taken out of use.

Step 2: Receiving a search term. This term might be, for example, a text string comprising or consisting of brand name or genuine domain and/or sub-domain name.

The search term may be input at the network end point 1 and communicated by the end point 1 to the central server 2, and from the central server 2 to the crawler database 3. Alternatively, the search term may be input at the central server 2.

In one example, the service makes available a web page into which a user inputs the required search term. Alternatively, the search may be a query over an application programming interface (API) or a database lookup, which may be a saved query which is run automatically at pre-determined intervals. The format of the search may be determined by the software in use at the end point 1 or central server 2.

Step 3: Searching the database to identify domain and/or sub-domain names that contain the search term or a derivative thereof and saving the results as a first list of possibly suspect domain and sub-domain names.

The search is configured broadly in order to retrieve all matches relating to one or more brand asset names (e.g. “example”) or to the domain and/or sub-domain name of the genuine website 4 of the brand asset owner (e.g. “example.com”). The matches may include homoglyphs and other permutations or derivatives of the genuine domain and/or sub-domain and/or brand asset name, as well as partial matches. It is advantageous to look beyond mere typosquatting and homoglyph matches, and to look for partial matches against entire strings, e.g. “abcdEXAMPLEasdj.fsfdskl.aaa” matches the search term “example”. Whilst this may result in a very long initial list, it ensures that most if not all fraudulent sites are identified. The long list is filtered as described below.

As the crawler database 3 contains all known IP addresses and all known domain and/or sub-domain names, a search of the crawler database 3 is the equivalent of a search of the entire accessible Internet.

The crawler database 3 may only be available for querying online, i.e. via the Internet. Alternatively, it may be possible to query the crawler database offline by accessing a copy of the dataset as it appeared at a particular time and date.

The generated list of possibly suspect domain and sub-domain names is communicated from the crawler database 3 to the central server 2 and is stored in a memory of the central server 2 pending further processing. This list is referred to below as the “long” list.

Step 4: Identifying clearly fraudulent and/or malicious domain and/or sub-domain names within the long list generated at step 3.

This step may be carried out manually by a user at either the end point 1 or the central server 2, or both. It will be appreciated that the manual search may be carried out by more than one user. The user may comprise one or more humans or may comprise a form of artificial intelligence, or a combination of both.

The long list produced at step 3 is manually reviewed or searched until one or more clearly fraudulent and/or malicious domain and/or sub-domain names is or are identified. This may be achieved by reviewing the domain and/or sub-domain names contained in the long list. For instance, a domain or sub-domain name such as “fakeexample.com” or “how-to-hack-example.foobar.com” has a high probability of being a fake or fraudulent website, or at the very least a website which the owner of the brand “example” may wish to take action against. These domain or sub-domain names (e.g. “fakeexample.com/shopping”) may therefore be selected as obviously fraudulent.

The manual search may identify individual URLs within a domain or sub-domain name, or may identify one or more domain and/or sub-domain names.

External databases may also be queried to determine whether a domain/sub-domain name on the list is known to be fraudulent, malicious or otherwise of interest. For example, a domain/sub-domain name reputation system or a “black list” may be checked in order to confirm the nature of an identified domain or sub-domain name.

The result(s) of the manual search are entered/selected at the end point 1 and communicated by the end point 1 to the central server 2, or are entered/selected directly at the central server 2.

This manual step allows accurate identification of fraudulent/malicious domain/sub-domain names which may not be identified at all via a similarity algorithm, or may be identified but given insufficient weight. It will be appreciated that as Internet fraud becomes increasingly sophisticated, differences between fraudulent/malicious websites and a genuine website may become increasingly difficult to identify. The improved method described herein may therefore take advantage of the superior decision-making abilities and experience of a human reviewer, either directly or making use of Artificial Intelligence based on human experience and processing.

Step 5: Querying the crawler database 3 to identify domain and/or sub-domain names that are linked or closely associated with the one or more clearly fraudulent and/or malicious domain and/or sub-domain names identified in step 4.

The crawler database is queried in substantially the same way as at step 3 to generate a list of domain and/or sub-domain names which are related to (i.e. linked to or closely associated with) the one or more clearly fraudulent and/or malicious domain and/or sub-domain names, identified at step 4. It will be appreciated that details of linked or associated domain names are already stored in the crawler database 3 as discussed with reference to FIG. 1 above. The results of the query are communicated from the crawler database 3 to the central server 2 and stored in memory there.

The purpose of step 5 is to find further fraudulent or malicious domain and/or sub-domain names on the basis of their association or link with the previously generated list of clearly fraudulent domain/sub-domain names. In this way, “clusters” of fraudulent domain/sub-domain names may be discovered from just one or a small number of clearly fraudulent and/or malicious domain and/or sub-domain names. It is well known that phishing websites, for example, include links to other phishing or otherwise fraudulent websites. However, phishing websites also often include links to domain/sub-domain names, such as the terms and conditions of the bank which the phishing website is attempting to mimic. Therefore, not all domain and sub-domain names linked to a fraudulent website may be fraudulent. Even where linked or associated websites are clearly also fraudulent, they may not be of interest to the brand asset owner if they are misusing the brand assets of a different, unconnected owner.

In an alternative embodiment, the method may also comprise carrying out a similarity check on the web pages or resources hosted behind the domain and/or sub-domain names listed at step 3 (the long list), based upon the content and/or structure of the genuine domain/sub-domain names.

This similarity check uses one or more known similarity lookup methods, as described above, or a combination thereof, to identify web pages or resources having similar content or structure to the resources point to by a genuine web page. This generates a list of domain and/or sub-domain names which contain the search term or a derivative thereof (i.e. the genuine domain/sub-domain name and/or the brand name) and which also have similar page or resource content to the genuine web page. These domain and/or sub-domain names may point to phishing websites.

In another alternative embodiment, the method may also comprise carrying out a similarity check on the web pages or resources located behind the domain and/or sub-domain names listed at step 3 (the long list), based upon the content and/or structure of the clearly fraudulent and/or malicious domain/sub-domain names determined at step 4. This generates a list of domain and/or sub-domain names which contain the search term or a derivative thereof and which also have similar page or resource content to the clearly fraudulent and/or malicious web page. These domain and/or sub-domain names may point to further fraudulent/malicious websites.

Where one or more of the above-mentioned similarity checks are carried out, the results of these checks may be combined with the results from step 4 above. The combined results may then be used to query the crawler database 3 at step 5.

In a further alternative embodiment, prior to querying the crawler database the combined results of the one or more similarity checks and the results from step 4 may be categorised in order to identify the group of domain/sub-domain names most likely to be fraudulent. The categorisation may be automated based upon “scores” generated for the web content at each domain/sub-domain name by the similarity checks described above. The “score” assigned is a probability or confidence level generated by the algorithms and methods used in the similarity check. Alternatively, the categorisation step may be carried out manually. Hence, the categorisation step may be carried out by the processor at the central server 2 or by a human user at either the central server 2 or the end point 1. The advantage of carrying out the categorisation with a human user is that, as previously discussed, humans are more adept at identifying truly fraudulent domain/sub-domain names.

During categorisation, the domain and/or sub-domain names are divided into groups or categories depending upon their probability of being fraudulent. Those most likely to be fraudulent will therefore form a first group, while those least likely to be fraudulent will form another group. One or more further groups of greater or lesser probability of being fraudulent may also be created.

The group of domain/sub-domain names which is considered to be most likely to be fraudulent may be communicated to the central server 2 (in the case where the categorisation step is carried out at the end point 1) and stored in the memory of the central server 2. This group may then be used at step 5 when querying the crawler database for linked or related sites.

Step 6: Combining the domain and/or sub-domain names identified at steps 4 and 5 to generate a second list of highly suspect domain and/or sub-domain names.

The output of the crawler database query carried out at step 5 is a list of linked or related domain and/or sub-domain names. This list is combined with the list generated at step 4 to form a “combined” list of domain and/or sub-domain names that are one or more of: clearly fraudulent and/or malicious, or linked to a clearly fraudulent and/or malicious domain/sub-domain name. The “combined list” may be presented as a list of domain and/or sub-domain names, or may further include individual URLs, depending upon the user's requirements or upon the results of the search.

Where the one or more similarity checks are carried out as described above, the “combined” list may also comprise one or more of: domain and/or sub-domain names that point to resources that are similar (in terms of page content or structure) to the resources pointed to by genuine domain/sub-domain name; domain and/or sub-domain names that point to resources that are similar (in terms of page content or structure) to the resources pointed to by clearly fraudulent domain/sub-domain names; domain and/or sub-domain names that are linked or related to the aforementioned domain/sub-domain names.

In yet a further embodiment, another similarity check may be carried out on the list of linked domain/sub-domain names found at step 5. In other words, linked or associated domain/sub-domain name that point to resources which are similar in terms of page content or structure to the resources pointed to by genuine domain or sub-domain names are identified. This may be used to reduce the length of the “combined list” by removing any linked domain/sub-domain names which have no similarity to the content or structure of the genuine website, and which may therefore be of no interest to the brand owner.

All or some of the steps of the above method may be repeated using different search terms, as further fraudulent domain/sub-domain names are identified. For example, the search carried out at step 3 may be repeated using the clearly fraudulent domain/sub-domain names found at step 4 as the search term, i.e. finding domain/sub-domain names in the database which match the search term “fakeexample” rather than the search term “example”. The results of this additional search can be used to extend the long list generated at step 3.

The above improved method of finding fraudulent and/or malicious Internet domain and/or sub-domain names provides a brand asset owner, for example, with a list of individual sub-domain and/or domain names (and possibly other URLs) which have a high probability of being fraudulent or malicious. The method overcomes the shortcomings of purely automated searches and is much faster than entirely manual searching would be. The use of manual steps within an otherwise automated method provides greater accuracy without unduly increasing the time required to complete the steps of the method.

The identification of fraudulent and/or malicious Internet domain and/or sub-domain names, using the methods described herein, enable a brand asset owner to take action against the perpetrators of these domain names, where possible. This may lead to the fraudulent and/or malicious domain and/or sub-domain name being taken down so that it is no longer live.

Additionally or alternatively, the identified domain/sub-domain names can be added to one or more blacklists. Such blacklists may be incorporated into anti-malware and/or anti-virus software so that a domain/sub-domain appearing on the blacklist becomes blocked and cannot be visited by a user of the software. Alternatively, access to that domain/sub-domain may be restricted. The user's computer is thereby protected from becoming infected by malware which, as described above, can cause the computer (or networks or other network components) to run more slowly, to crash or to become unusable. In the case of a phishing website, the user's confidential details are protected from being stolen. In the case of a counterfeit goods website, the user is protected from purchasing counterfeit goods. The identification and blocking of a fraudulent and/or malicious domain/sub-domain name is particularly effective in addressing the problem of “drive-by” downloads, in which malware is downloaded onto a user's computer as soon as the user visits the website, without requiring any user interaction (e.g. clicking on pop-ups or download windows).

It will be understood by the person of skill in the art that various modifications may be made to the above described embodiments without departing from the scope of the present invention.

1. A method of identifying fraudulent and/or malicious Internet domain and sub-domain names, the method comprising:
a) crawling the web to identify in-use domain and/or sub-domain names and storing these in a database together with data linking domain and sub-domain names that have been determined to be associated with suspicious behaviours;
b) receiving a search term;
c) searching the database to identify domain and/or sub-domain names that contain the search term or a derivative thereof and saving the results as a first list of possibly suspect domain and sub-domain names;
d) identifying within said first list one or more domain and/or sub-domain names that appear to be clearly fraudulent and/or malicious;
e) using said database to identify domain and/or sub-domain names that are linked, in the database, to the domain and/or sub-domain names identified in step d); and
f) combining the domain and/or sub-domain names identified in steps d) and e) to generate a second list of highly suspect domain and/or sub-domain names.

2. A method according to claim 1, wherein step d) comprises displaying the first list on a computer display and receiving a user input identifying said one or more domain and/or sub-domain names that appear to be clearly fraudulent and/or malicious.

3. A method according to claim 1, comprising:
g) identifying within the first list, domain and/or sub-domain names pointing to resources similar to resources pointed to by the one or more clearly fraudulent and/or malicious domain and/or sub-domain names identified at step d),
h) using the database to identify domain and/or sub-domain names that are linked, in the database, to the domain and/or sub-domain names identified in step g);
i) combining the domain and/or sub-domain names identified in step h) with the second list of highly suspect domain and/or sub-domain names.

4. A method according to claim 1, comprising:
j) identifying within the first list, domain and/or sub-domain names pointing to resources similar to resources pointed to by domain and/or sub-domain names genuinely associated with the search term;
k) using the database to identify domain and/or sub-domain names that are linked, in the database, to the domain and/or sub-domain names identified in step j);
l) combining the domain and/or sub-domain names identified in step k) with the second list of highly suspect domain and/or sub-domain names.

5. A method according to claim 3, wherein similar resources are identified using one or more of the following algorithms: Jaccard distance calculations, LSH, MinHash or combinations thereof.

6. A method according to claim 1, comprising:
categorising the identified domain and/or sub-domain names according to a probability of said domain and/or sub-domain names being fraudulent; and
identifying those domain and sub-domain names that have a high probability of being fraudulent, and using the database to identify domain and/or sub-domain names that are linked, in the database, to the domain and/or sub-domain names having a high probability of being fraudulent.

7. A method according to claim 1, wherein the search term comprises a text string.

8. A method comprising iteratively applying the steps of claim 1, wherein, at the end of each iteration, the resulting list is used to define a new search term.

9. A method according to claim 1 and comprising carrying out said step of crawling the web using a web crawler hosted on one or more servers.

10. A method according to claim 1, the method being implemented on one or more servers and comprising providing a client portal to which client computers can connect and via which said search term can be received from a client computer.

11. A method according to claim 10, said client portal providing a means to present said second list to the client computer.

12. A method of securing a computer system against malware and comprising using the method of claim 1 to identify fraudulent and/or malicious Internet domain and sub-domain names and blocking or restricting access to those Internet domain and sub-domain names at the computer system or at a network node to which the computer system is connected.

13. A system for identifying fraudulent and/or malicious Internet domain and/or sub-domain names, the system comprising:
a web crawler coupled to the world wide web to identify in-use domain and/or sub-domain names;
a searchable database for storing identified in-use domain and/or sub-domain names and for storing data linking domain and sub-domain names that have been determined to be associated with suspicious behaviours;
a server comprising a memory and a processor, the server configured to receive a search term, to search the database for domain and/or sub-domain names that contain the search term or a derivative thereof, and to save the results of the search in the memory as a first list of possibly suspect domain and sub-domain names; and
the server further configured to identify one or more domain and/or sub-domain names, in the first list, that appear to be clearly fraudulent and/or malicious, to search the database to identify domain and/or sub-domain names that are linked, in the database, to the one or more clearly fraudulent and/or malicious domain and/or sub-domain names, and to combine the identified linked domain and/or sub-domain names with the first list to generate a second list of highly suspect domain and/or sub-domain names.

14. A computer program product comprising a computer storage medium having computer code stored thereon which, when executed on a computer system, causes the system to operate as a system according to claim 13.
